(19) United States
(12) Patent Application Publication
(10) Pub. No.: US 2006/0215804 A1
(43) Pub. Date: Sep. 28, 2006

(54) Inhibitor of corrosion and stress corrosion cracking containing nickel boride (NiB) in the secondary side of steam generator tubes in a nuclear power plant and inhibiting method using the same

(75) Inventors: Yongsun Yi, Daejeon (KR); Hongpyo Kim, Daejeon (KR); Joungsoo Kim, Daejeon (KR)

Correspondence Address: BACHMAN & LAPOINTE, P.C., 900 CHAPEL STREET, SUITE 1201, NEW HAVEN, CT, 06510, US

(73) Assignee: Korea Atomic Energy Research Institute and Korea Hydro & Nuclear Power Co., Ltd.

(21) Appl. No.: 11/283,247

(22) Filed: Nov. 17, 2005

(30) Foreign Application Priority Data
Mar. 10, 2005 (KR) 10-2005-0020271

(51) Int. Cl. G21C 9/00

(52) U.S. Cl. 376/305

(57) ABSTRACT

An inhibitor of corrosion and stress corrosion cracking including nickel boride (NiB) in a secondary side of a steam generator tube in a nuclear power plant and an inhibition method using the same. The nickel boride (NiB) according to the present invention reduces stress corrosion cracking in a testing plate simulating the steam generator tube in the nuclear power plant in a highly caustic condition when compared with a reference solution, and increases corrosion resistance by reducing corrosion current density and oxide thickness. Accordingly, nickel boride may be effectively used to inhibit corrosion and stress corrosion cracking in the secondary side of the steam generator tube in the nuclear power plant.

### CROSS-REFERENCE TO RELATED APPLICATION

This application claims priority to and the benefit of Korean Patent Application No. 10-2005-0020271, filed in the Korean Intellectual Property Office on Mar. 10, 2005, the entire content of which is incorporated herein by reference.

### BACKGROUND OF THE INVENTION

(a) Field of the Invention

The present invention relates to a method of inhibiting corrosion and stress corrosion cracking, using nickel boride (NiB), in a secondary side of a steam generator tube in a nuclear power plant, and a corrosion inhibitor being fed to a secondary feedwater.

(b) Description of the Related Art

Commercial nuclear reactors operating in the world are generally classified into a pressurized water reactor (PWR) and a boiling water reactor (BWR) developed in U.S., a high temperature gas cooled reactor (HTGR) developed in U.K., and a pressurized heavy water reactor (PHWR) developed in Canada. Pressurized water reactors (PWR) and boiling water reactors (BWR) are commonly used in the world now. In Korea, all nuclear power plants except Wolsong nuclear power plant are utilizing the pressurized water reactors. The pressurized water reactor (PWR) uses a low-enriched uranium fuel containing 2-5% Uranium 235 and water as a coolant and moderator. Water within the reactor is maintained below the boiling point by pressurizing a reactor system by about 150 atmospheric pressure, heated water is supplied to a steam generator and converted into steam through heat-exchange with water in a secondary side of the steam generator. Heat-exchanged water in a primary side is recirculated into the reactor, heated and supplied to the steam generator. The above process is repeated continuously.

One of the accidents occurring often in the pressurized water reactors is a leakage in steam generator tubes. Various causes of the leakage may be considered, and one of them is a thickness decrement of the tubes. Eddy current inspection of the steam generator tube shows that thickness decrement of the tube is found in the vicinity of a tube plate deposited with a large amount of sludge containing iron oxides and copper mixtures. The amount of accumulated sludge may be estimated by eddy current testing of a low frequency signal sensitive to magnetite contained in the sludge: An amount of sludge correlates to a location of a tube wall decrement because sludge precipitates on a tube wall provide a place where liquid phosphoric acid or other corrosion materials are concentrated, and thereby the thickness decrement of the tube occurs. One of the publicly disclosed methods to remove the sludge is “sludge lance-suction method” (Korea Patent Publication No. 1981-0000034).

Another cause of the leakage in the steam generator tube is supposed to be related to a chemical environment in a feedwater side of the steam generator tube. According to an analysis of a specimen taken from steam generator tubes of a leaking steam generator, it showed that the leakage is caused by a defective tube due to intergranular corrosion. Similarity between a large amount of corrosive materials found near a location of cracked tube taken from a steam generator and corrosive materials formed by a corrosion test in a controlled laboratory condition is noticed and considered as a cause of intergranular corrosion, namely, a cause of cracking in a steam generator tube.

Accordingly, material of a steam generator tube is one of the important factors in a cracking of the steam generator tube, and Inconel alloy 600 containing Ni is being used as a material of the steam generator tube in an atomic power plant. Inconel alloy 600 is being used as a material of the steam generator tube in the pressurized water reactor due to excellent mechanical properties and corrosion resistance. In spite of the above advantages, alloy 600 is susceptible to stress corrosion cracking in a hot water and highly basic environment in the primary and secondary sides, and intergranular corrosion and stress corrosion cracking occurs frequently in a basic condition and more frequently in the material of the secondary side tube of the pressurized water reactor currently operating worldwide.

Intergranular corrosion is defined as follows. Austenitic stainless steel forms chromium carbide (Cr₂₃C₆) in a granular boundary when heated at 500-800° C., the amount of chromium (Cr) adjacent to the chromium carbide is reduced and a chromium-depleted area is formed. This is called “Sensitization treatment”. When the above treated steel is immersed in an acidic solution, the chromium-depleted area is highly corroded and fallen away. This is called “intergranular corrosion”.

Stress corrosion cracking is a brittle fracture of a metal induced from the combined influence of tensile stress and a corrosive environment, and occurs only when a specific combination of three factors, such as a material, an environment and a stress, are satisfied. Passivation film is generally formed on a surface of a material having excellent corrosion resistance. However, the film is destroyed locally by external factors and becomes a starting point of pitting or stress corrosion cracking. The film is formed and destroyed only in a specific condition, and the cracking progresses as described above. If protection property of a surface layer is not sufficient, a uniform corrosion occurs and the stress corrosion cracking does not occur. Accordingly, the stress corrosion cracking occurs only in materials having superior corrosion resistance. A material having high cracking resistance in a specific environment may show stress corrosion cracking in another environment. Namely, there may be an environment in which materials may be susceptible to stress corrosion cracking.

Intergranular corrosion and stress corrosion cracking occurring in steam generator tubes may cause a leakage of cooling water in a primary side and stoppage of operation in a nuclear plant as well as repair of damaged steam generator tubes and even exchange of steam generators themselves, and thereby causes a considerable economic loss.

A forecasting system for predicting defects occurring in the steam generator tubes has been developed to reduce accidents and losses caused by the corrosion and stress corrosion cracking of steam generator tubes, and research and development on alternative alloys, proper hydrochemical treatments (secondary side water treatment) and improvement in machining processes of steam generators have been carried out to reduce deterioration occurring in various materials of components through which cooling water passes in a secondary side of the steam generator.

Especially, various researches on development and application of corrosion inhibitors have been recently carried out in order to inhibit corrosion and stress corrosion cracking in the secondary side.

For example, Inconel alloy 690 has been developed as an alternative alloy. Inconel alloy 690 has better stability than conventional Inconel alloy 600 in a high temperature condition. However, Inconel alloy 690 has a disadvantage that a larger heat transfer area is required at the same temperature because it has lower heat conductivity than Inconel alloy 600. A method of injecting ammonia and hydrazine is used in a conventional water treatment to maintain the pH of cooling water and concentration of dissolved oxygen (DO) in a proper level in the secondary side (Japanese Patent Publication No. 61-149501). In many nuclear power plants operating now, boric acid is added to a secondary side feedwater as a corrosion inhibitor to inhibit stress corrosion cracking of a steam generator tube. However, stress corrosion cracking may still occur.

Recently, a method using titanium oxide as a corrosion inhibitor in a high temperature and basic environment has been reported, and actually applied for field tests. However, inhibition effect in a nuclear power plant is not quantitatively verified yet. It is increasingly reported that intergranular corrosion and stress corrosion cracking are accelerated by lead components such as lead oxide, lead chloride and lead sulfide contained in a secondary side of a steam generator. However, a corrosion inhibitor to solve the above problem has not been developed at all. Recently, It is reported that cerium boride (CeB₆) and lanthanum boride (LaB₆) are developed as new inhibitors of stress corrosion cracking, and stress corrosion cracking may be reduced remarkably by adding them to cooling water in the secondary side to form a chromium enriched film which protects the surface of steam generator tubes strongly from the corrosive environment. When the above technique is applied, inhibition effect of stress corrosion cracking is at least 10 times higher than the case of no inhibition treatment, and at least 5 times higher than the case of adding titanium oxide (TiO₂) (Korean Patent No. 415265). However, the cerium boride (CeB₆) and lanthanum boride (LaB₆) have not been applied for field tests yet, and thereby additional experiments or field application results may be required to guarantee inhibition effect in a field application.

During the research on effective inhibitors and methods of inhibiting corrosion and stress corrosion cracking in the secondary side of a steam generator in a nuclear power plant, which may be practically used in a field application, the researchers found that nickel boride (NiB) may be effectively utilized to inhibit corrosion and stress corrosion cracking in the secondary side of the steam generator tubes because the nickel boride (NiB) increases corrosion resistance by reducing corrosion current density and oxide thickness, and thereby reduces stress corrosion cracking of a testing plate simulating the steam generator tube.

### SUMMARY OF THE INVENTION

An object of the present invention is to provide an inhibitor of corrosion and stress corrosion cracking containing nickel boride (NiB) in a secondary side of steam generator tubes in a nuclear power plant.

Another object of the present invention is to provide a method of inhibiting corrosion and stress corrosion cracking in a secondary side of steam generator tubes in a nuclear power plant, the method including a step of supplying nickel boride to a secondary side feedwater system as a inhibitor of corrosion and stress corrosion cracking.

### BRIEF DESCRIPTION OF THE DRAWINGS

FIG. 1 is a graph showing a corrosion inhibition effect of nickel boride (NiB) having an influence on a corrosion current density obtained from a polarization curve.

FIG. 2 is a graph showing oxide thickness on surfaces of testing plates after a slow strain rate tensile (SSRT) test in a reference solution of ammonia (pH_{RT} 9.5), the solution with cerium boride (CeB₆) and the solution with nickel boride (NiB).

FIG. 3 shows photos of side surfaces of testing plates taken with a scanning electron microscope (SEM) after a slow strain rate tensile (SSRT) test in a reference solution of 40% NaOH, the solution with cerium boride (CeB₆) and the solution with nickel boride (NiB).

FIG. 4 shows photos of side surfaces of testing plates taken with a scanning electron microscope (SEM) after a slow strain rate tensile (SSRT) test in a reference solution of ammonia (pH_{RT} 9.5), the solution with cerium boride (CeB₆) and the solution with nickel boride (NiB).

### DETAILED DESCRIPTION OF THE INVENTION

The present invention provides an inhibitor of corrosion and stress corrosion cracking containing nickel boride (NiB) in a secondary side of a steam generator tube in a nuclear power plant.

More preferably, the present invention provides an inhibitor of corrosion and stress corrosion cracking whose amount is 10 ppb˜2000 ppm when used in a secondary feedwater.

To measure corrosion inhibition effect of nickel boride (NiB), a conventional testing plate used for corrosion experiment of a metal is manufactured. A portion of the testing plate material is prepared by cutting, and a direction or location where the testing plate is taken may be different according to types of experiment. Metals used for steam generator tubes are utilized as the materials of the testing plate according to the present invention, and more preferably, Inconel alloy 600 is used. Generally, a tested surface of the testing plate has an angular or circular shape of 10-25 mm, and a proper height of the testing plate is a half of a sectional size. In the present invention, the testing plate having an elongation part of the length of 25 mm, the width of 4 mm and the thickness of 1.07 mm is prepared. For easy handling, the cut testing plate may be mounted to fix securely to the edges with a material such as a polymer. A testing surface of the plate is prepared to form a completely flat surface without any rough scratch by grinding.

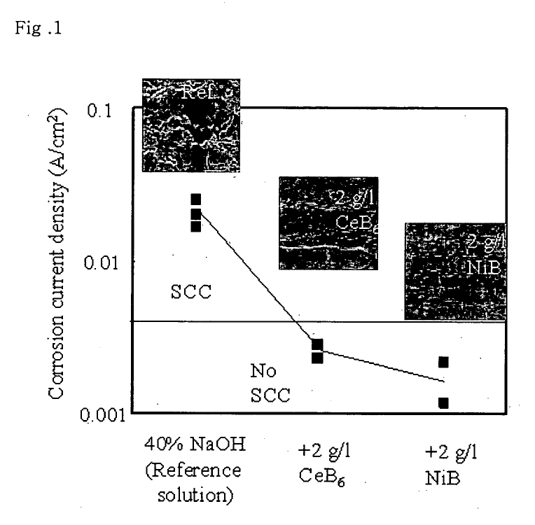

Nickel boride (NiB) according to the present invention increases corrosion resistance by reducing a corrosion current density of a steam generator tube material. Especially, in a highly caustic condition or high temperature/basic condition simulating the water chemistry in the secondary side during the normal operation, the addition of the nickel boride reduces corrosion current density and decreases corrosion rate in proportion thereto, when compared with a reference solution without nickel boride (FIG. 1).

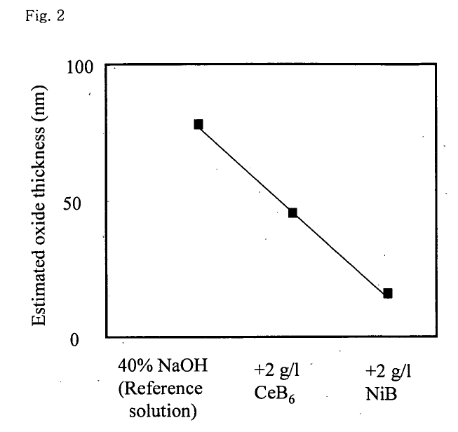

Nickel boride according to the present invention reduces surface oxide thickness of steam generator tube materials. Especially, in a highly caustic condition or high temperature/basic condition simulating the water chemistry in a secondary side during a normal operation, an addition of nickel boride further increases corrosion resistance by decreasing the surface oxide thickness of the steam generator tube materials when compared with the reference solution without nickel boride (FIG. 2).

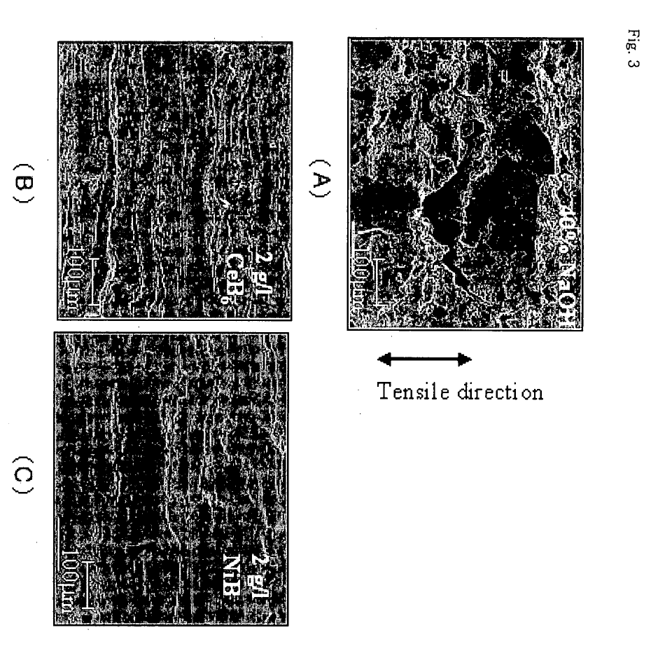

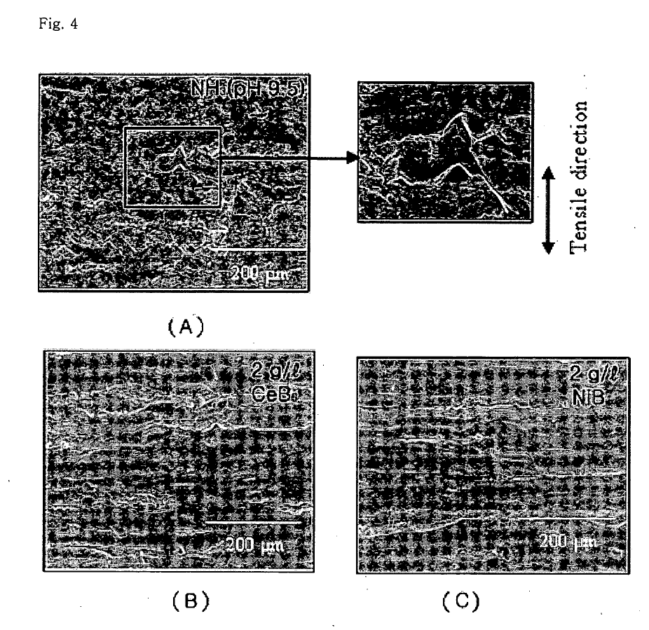

Nickel boride according to the present invention reduces stress corrosion cracking of the steam generator tube materials. Especially, in a highly caustic condition or high temperature/basic condition simulating the water chemistry in the secondary side during the normal operation, the addition of nickel boride remarkably reduces stress corrosion cracking when compared with the reference solution without nickel boride (FIGS. 3 and 4).

The stress corrosion cracking is measured using a slow strain rate tensile (SSRT) test in which a strain rate is an important factor. If the strain rate is too fast, cracking does not occur. Therefore, a proper strain rate should be applied. A stress-strain curve is obtained by testing a testing plate at a predetermined strain rate, and the cracking is evaluated by whether or not the stress corrosion cracking occurs.

The above effect may be obtained with nickel boride having the concentration range of 10 ppb˜2000 ppm. Corrosion and stress corrosion cracking in the secondary side of the steam generator tubes may be reduced by using 10 ppb-2000 ppm of nickel boride which is a smaller than the amount (50 ppb-5000 ppm) of conventional corrosion inhibitors containing cerium boride (CeB₆) and lanthanum boride (LaB₆).

Availability of cerium boride (CeB₆) and lanthanum boride (LaB₆) is not verified in actual steam generators operating in power plants because corrosion inhibition effect of them has been proven only in a caustic condition. However, nickel boride may be instantly applied to actual power plants because the inhibition effect of nickel boride has been proven in the caustic condition and normal water chemistry of nuclear power plants.

Accordingly, nickel boride according to the present invention reduces a surface oxide thickness of a steam generator tube material in a highly caustic secondary side, increases corrosion resistance by reducing corrosion current density, and inhibits stress corrosion cracking. Therefore, nickel boride may be used as an inhibitor of corrosion and stress corrosion cracking in the secondary side of the steam generator tubes in the nuclear power plant.

In a method of inhibiting corrosion and stress corrosion cracking in the secondary side of the steam generator tube in a nuclear power plant, the present invention provides a method including a step of supplying the nickel boride to the secondary side of a feedwater system as an inhibitor of corrosion and stress corrosion cracking.

The present invention provides a method of inhibiting corrosion and stress corrosion cracking, whrerein the amount of an inhibitor used in the secondary feedwater is 10 ppb˜2000 ppm.

The pH_{RT} of the above feedwater is 7.0 or more at room temperature and more preferably, may be in the range of 9.0-10.0.

A method of inhibiting corrosion and stress corrosion cracking in the secondary side of the steam generator tube in a nuclear power plant includes a step of injecting nickel boride into feedwater as a method of a secondary side feedwater treatment, improves corrosion resistance of the steam generator tube, and thereby increases resistance to corrosion and stress corrosion cracking. The feedwater is cooling water that receives heat generated from a reactor through the steam generator and transmits a driving force to a turbine.

A method of inhibiting corrosion and stress corrosion cracking includes a step of injecting 10 ppb˜2000 ppm of nickel boride into cooling water in the secondary side having pH_{RT} 7.0 or higher at room temperature, and more preferably, pH_{RT} 9.0˜10.0, and remarkably decreases corrosion of the steam generator tube materials in a highly caustic condition simulating the secondary side condition in the steam generator tubes, and thereby increases resistance to stress corrosion cracking.

Accordingly, the above method of inhibiting corrosion and stress corrosion cracking may remarkably increase the resistance to corrosion and stress corrosion cracking in the secondary side of a steam generator tube by adding nickel boride because the secondary side of the steam generator tube is maintained at pH_{RT 9.5} at room temperature, and a crevice, on which stress corrosion cracking is concentrated and has a higher pH_{RT} value, between a steam generator tube and support structures.

Preferable exemplary embodiments and experiments are provided for better understanding of the present invention. The exemplary embodiments and experiments have been described hereinafter for better understanding of the present invention, and the present invention should not be construed as being limited to the exemplary embodiments set forth herein.

### EXAMPLE 1

### Effect of Nickel Boride on Corrosion and Stress Corrosion Cracking of a Steam Generator Tube Material

To measure effect of nickel boride on corrosion and stress corrosion cracking of a steam generator tube, a testing plate made of Inconel alloy 600 is used, which is the same material as the steam generator tube installed at the nuclear reactors No. 3 and 4 located at Youngkwang, Korea. The testing plate with a gage section having the length of 25 mm, the width of 4 mm and the thickness of 1.07 mm was machined and used in an experiment.

The experiment was carried out in 40% NaOH solution which is regarded as the severest environment at a crack-generating area in a secondary side and in an ammonia solution (pH_{RT 9.5}) at 315° C. simulating the water chemistry in the secondary side during normal operation.

1-1. Measurement of Polarization

To evaluate corrosion characteristics, measurement of polarization is carried out using a testing plate in 40% NaOH solution and in a static autoclave made of Ni-80, having if capacity. Ag/AgCl (saturated KCl) electrode is used as a reference electrode and the autoclave itself is used as a counter electrode. 40% NaOH solution (315° C.) is used as a reference solution, and is deaerated by high purity nitrogen for 24 hours to remove dissolved oxygen (DO) before the measuring. Polarization is measured using a Potentiostat (Model 273A, EG&G), and a surface oxide formed in the air is removed by treating for 30 min. at −1.5V (vs. open circuit potential (OCP), corrosion potential). The measurement of polarization is carried out at the rate of 1 mV/sec from −1.5V(vs. OCP) to +1.5V(vs. OCP).

Polarization curves obtained from the measurement of polarization are analyzed using four point method. The four point method is proposed by Jankowski and Juchniewicz, and determines corrosion current density by using current density value obtained near a corrosion potential. Current densities at a corrosion potential (open circuit potential) obtained from the analysis is shown in FIG.1. When 2 g/l cerium boride and 2 g/l nickel boride are added respectively, corrosion current densities are remarkably reduced with respect to that in the reference solution. When nickel boride is added, corrosion current density is reduced to about half of that in a solution with cerium boride, and increases corrosion resistance by about two times.

1-2. Measurement of Oxide Thickness

Surface oxides formed in ammonia solution (pH_{RT} 9.5) are analyzed by Auger electron microscopy (AEM) and oxide thicknesses are shown in FIG. 2.

PHI 680 Auger nanoprobe is used as Auger electron microscopy, primary beam energy is 5 kV and electron current is 15-20 nA. To measure the thickness, argon ions having the energy depth of 1-4 keV are applied. Compositions in depth direction are measured by cutting a surface at the rate of 27 nm/min, and surface oxide thickness is estimated by the basis of oxygen concentration.

When 2 g/l nickel boride is added, it is found that oxide thickness is remarkably reduced compared with the reference solution (NaOH) or the case of adding 2 g/l cerium boride. This means that the addition of nickel boride increases the corrosion resistance of the tube materials even in ammonia solution.

1.3 Slow Strain Rate Tensile (SSRT) Test

Evaluation testing of stress corrosion cracking is conducted in a 1.8 l static autoclave (Cortest, USA) made of alloy 625. Maximum load of the tester is 2722 kgf (6000 lbf) and elongation rate is 3.53×10⁻⁷˜2.64×10⁻³ mm/s. To measure the stress corrosion cracking, a slow strain rate tensile (SSRT) test is conducted at 315° C. wherein the strain rate is 1×10⁻⁶ and 3×10⁻⁷ (s⁻¹) in caustic solution and ammonia solution respectively. The caustic solution is deaerated by nitrogen for 24 hours to remove dissolved oxygen before the test. However, the ammonia solution isn't deaerated to accelerate stress corrosion cracking. To simulate actual power plant situation, the test is conducted at a corrosion potential without applying any potential to the testing plate in the above two solutions.

FIG. 3 shows photos of side surfaces of testing plates taken with a scanning electron microscope (SEM) after a slow strain rate tensile (SSRT) test in 315° C. 40% caustic solution. FIG. 3 shows that a considerable cracking by intergranular stress corrosion occurs in the reference solution of 40% NaOH(a), and no intergranular stress corrosion cracking occurs in the 40% caustic solution with 2 g/l cerium boride (b) and the 40% caustic solution with 2 g/l nickel boride (c). Intergranular stress corrosion cracking is reduced in the solution with nickel boride than in the solution with cerium boride.

FIG. 4 shows photos of side surfaces of testing plates taken with the scanning electron microscope (SEM) after the slow strain rate tensile (SSRT) test in 315° C. ammonia solution (pH_{RT} 9.5). FIG. 4 shows that the intergranular stress corrosion cracking occurs in the ammonia solution (a) and the stress corrosion cracking is inhibited when 2 g/l cerium boride and 2 g/l nickel boride are added thereto respectively (b and c). Like the condition of 40% caustic solution described in the above, intergranular stress corrosion cracking is reduced in the solution with nickel boride than in the solution with cerium boride.

Accordingly, stress corrosion cracking is inhibited when nickel boride is added in a highly basic condition where a steam generator is operating.

As described in the above, by measuring polarization and oxide thickness in high temperature and highly basic condition, it is confirmed that corrosion resistance of a steam generator tube material is improved when nickel boride is added. By a slow strain rate tensile test, it is verified that nickel boride reduces stress corrosion cracking on a testing plate. Accordingly, nickel boride may be used as an inhibitor of corrosion and stress corrosion cracking that increases resistance to corrosion and stress corrosion cracking in a secondary side, at about pH_{RT} 9.5, of the steam generator and at an opening, on which the stress corrosion cracking is concentrated and having higher pH_{RT} than 9.5, between support structures and the steam generator tube

What is claimed is:

1. An inhibitor of corrosion and stress corrosion cracking being fed to secondary feedwater to inhibit the corrosion and stress corrosion cracking of a steam generator tube in a nuclear power plant, the inhibitor including nickel boride.

2. The inhibitor of corrosion and stress corrosion cracking of claim 1, wherein the amount of the inhibitor being fed to the secondary feedwater is 10 ppb˜2000 ppm.

3. A method of inhibiting corrosion and stress corrosion cracking in a secondary side of a steam generator tube in a nuclear power plant, the method including a step of supplying nickel boride to secondary feedwater as an inhibitor of corrosion and stress corrosion cracking.

4. The method of inhibiting corrosion and stress corrosion cracking of claim 3, wherein the amount of the inhibitor being fed to the secondary feedwater is 10 ppb˜2000 ppm.

5. The method of inhibiting corrosion and stress corrosion cracking of claim 3, wherein the pH_{RT} of the feedwater is higher than 7.0 at room temperature.

6. The method of inhibiting corrosion and stress corrosion cracking of claim 3, wherein the pH_{RT} range of the feedwater is 9.0˜10.0 at room temperature.
